(19) United States
(12) Patent Application Publication
(10) Pub. No.: US 2005/0184150 A1
(43) Pub. Date: Aug. 25, 2005

(54) Device to prevent credit card loss

(76) Inventors: Gregory Anthony Welte, Frankfort, IN (US); Mark Krull, Bend, OR (US)

Correspondence Address: Gregory A. Welte, 806 North County Road 700 West, Frankfort, IN, 46041, US

(21) Appl. No.: 10/786,546

(22) Filed: Feb. 24, 2004

(51) Int. Cl. G06F 17/60

(52) U.S. Cl. 235/385

(57) ABSTRACT

A system for assuring that no credit cards are missing from a purse. Each credit card carries a tag, such as an RFID tag. An RFID reader, carried in the purse, periodically polls the tags. The RFID reader expects a given number of resposes, corresponding to the number of tags ordinarily present in the purse. If fewer than the expected number of responses is received, indicating that a tag and its associated credit card are missing, the reader issues a warning, such as a beeping sound.

The invention concerns a device which ascertains whether an item such as a credit card, driver's license, or the like is missing from a wallet or purse, and issues a warning signal in response.

### BACKGROUND OF THE INVENTION

It is common for a person to inadvertantly leave a credit card or driver's license at a check-out station after making a purchase. This creates (1) inconvenience, (2) a loss of time in retrieving the card or license, and (3) the possibility of financial loss if the card or license falls into the hands of a dishonest person.

### OBJECT OF THE INVENTION

An object of the invention is to provide a system for tracking the contents of a purse, wallet, suitcase, and the like, and to ascertain the absence of certain items.

### BRIEF DESCRIPTION OF THE DRAWINGS

FIGS. 1 and 2 illustrate two forms of the invention.

### SUMMARY OF THE INVENTION

In one form of the invention, a tag is attached to each of several items in a purse, such as to all credit cards and drivers licenses. The tag may take the form of a commercially available RFID, Radio Frequency IDentification, transponder, and resembles a small postage stamp, though perhaps thicker.

An RFID reader is also present in the purse. Periodically, such as every minute, the RFID reader polls the tags. For example, if six tags should be present in the purse, the RFID reader asks whether all six tags are present, every minute. If one tag is missing, the RFID reader issues a warning, such as a beeping sound.

When the owner of the purse hears the beeping sound, the owner knows that an important item is missing from the purse. Further, the owner knows that the item went missing within the last minute, and can then correctly retrace steps to locate the item.

### DETAILED DESCRIPTION OF THE INVENTION

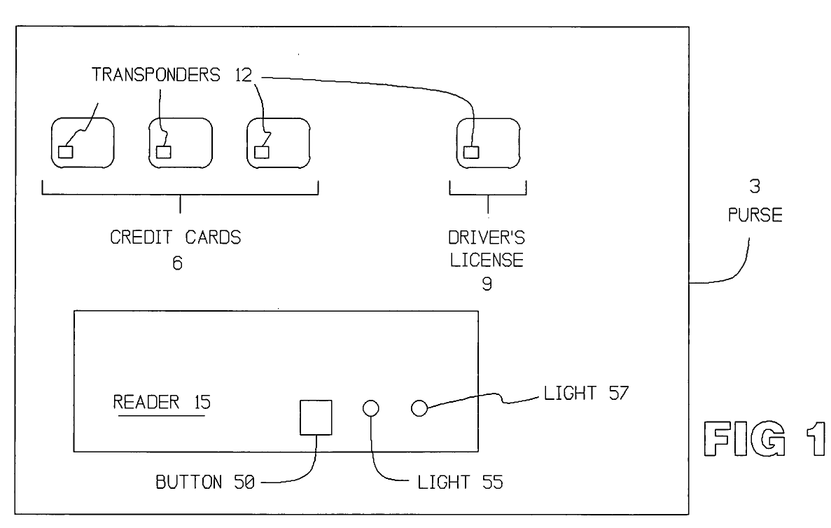

FIG. 1 shows a purse 3, which represents generically a piece of personal luggage associated with a person. Such luggage includes, without limitation, brief cases, valises, handbags, backpacks, wallets, suitcases, golf bags, and so on.

The purse 3 also contains a collection of items, such as credit cards 6 and a driver's license 9. Attached to each item is transponder 12. A reader 15 is also present in the purse.

In operation, the reader 15 periodically polls each transponder 12. In effect, the reader 15 periodically asks the following questions:
“Transponder 1, are you present?”
“Transponder 2, are you present?”
“Transponder 3, are you present?”
   and so on, through all transponders expected to be present in the purse 3.

If the reader 15 finds that a particular transponder is missing, thereby indicating that the item associated with that transponder is also missing, the reader 15 issues a warning, as by issuing a beeping sound.

Thus, for example, assume that the purse 3 contains three credit cards and one driver's license, all bearing transponders 12. Assume that the owner of the purse 3 embarks on a shopping trip. While the owner drives to a shopping mall, all credit cards and the driver's license remain safely stowed within the purse 3. Thus, during the drive, each time the reader 15 polls the transponders 12, the reader 15 finds that all transponders are present, so that the reader 15 issues no warning.

However, assume that, later, the owner of the purse makes a purchase using a credit card, and accidentally leaves the credit card at a check-out station. When the reader 15 takes its next poll, the reader 15 will find the transponder 12 associated with that credit card to be missing, and will issue a warning.

If the reader 15 takes a poll every minute, then the owner of the purse will learn of the missing credit card no later than one minute after its loss. It is a simple matter for the owner to retrace steps over the previous minute, to retrieve the card.

In one form of the invention, RFID, Radio Frequency IDentification, technology can be used to implement the functions just described. Transponders 12 can take the form of RFID transponders, each containing a unique serial number. The owner of the purse attaches a transponder 12 to each item to be tracked.

Reader 15 can take the form of an RFID reader. Syscan International, 208 Migneron Street, St-Laurent, Quebec, Canada, H4T 1Y7, produces an RFID reader in the form of a so-called “flash” card, which can be installed in handheld computers, and the like. Thus, reader 15 can take the form of a handheld computer equipped with such a flash card, together with appropriate programming.

One or both of U.S. Pat. Nos. 6,621,467 and 6,499,656 discuss a system which uses RFID technology to determine the contents of a shopping cart, to thereby produce a bill for the contents of the shopping cart. These two patents are hereby incorporated by reference. A similar approach can be used to determine the presence of the credit cards in a purse: the detector determines the number and type of RFID tags within the purse. If that number and type do not match a pre-existing list of numbers and types, then a warning is issued.

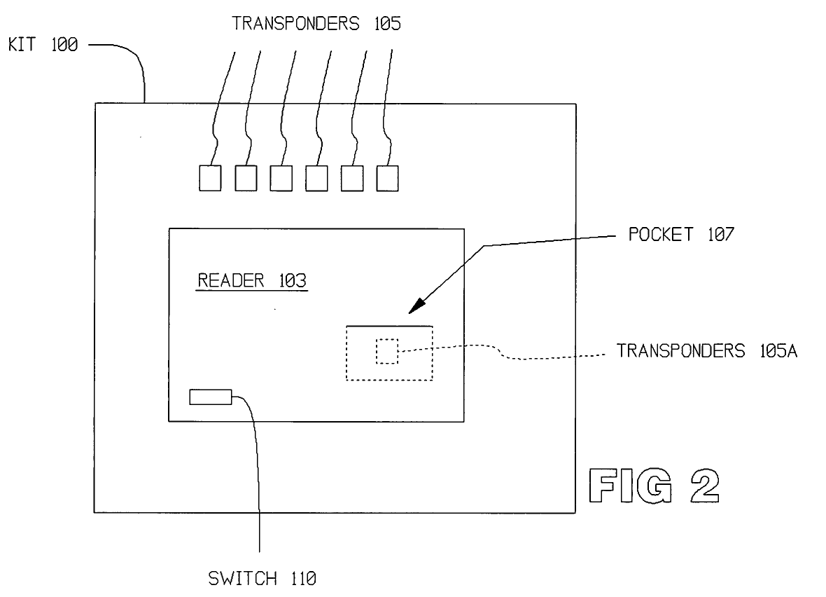

FIG. 2 illustrates one form of the invention. A kit 100 contains a reader 103, such as an RFID reader, and a number of transponders 105, such as six transponders. The reader 103 is pre-programmed to poll the six transponders, at predetermined intervals, or at intevals selectable by the user.

It is possible that the user does not need all six transponders 105, perhaps because the user only carries one credit card and one drivers license. In this case, the user stores unused transponders 105A in a pocket 107 associated with the reader 103. In this manner, the reader 103 detects the presence of the four transponders during every polling operation. Further, if a need for an additional transponder arises, perhaps because the user acquires an additional credit card, a transponder can be removed from the pocket 107 and attached to the additional card.

In one form of the invention, the following processes are undertaken. First, as preparation, the transponders are attached to items to be tracked. These items are not limited to card-like items, but can include keys, key fobs, tools, and any collection of goods which are to be maintained within the piece of luggage in question.

Then the reader 103 is activated. In one form of the invention, the transponder can be self-actuated, as when a vibration sensor, accelerometer, or digital compass detects movement of the piece of luggage. Alternately, the reader 103 remains actuated at all times.

Periodically, the reader 103 polls the transponders 107. In one approach, each transponder is programmed to issue a response after a time delay, and the time delays for the transponders are different. Further, the transponders may powered by energy contained in rf radiation which acts as the polling signal, or accompanies the polling signal.

In one form of the invention, each RFID tag is programmed to respond to the incoming polling signal with a different delay. For example, assume six RFID tags are present in a purse. Tag 1 is programmed to respond after one time unit. Tag 2, two time units. Tag 3, three time units. Tag 4, four time units. Tag 5, five time units. Tag six, six time units. Of course, each response takes a finite amount of time. Thus, the response will occur during a time window at or near the prescribed time delay.

It is pointed out that, in many RFID systems, the tags receive their operating power from the rf energy which is radiated from the reader.

In this example, the reader transmits an rf polling signal, which persists for at least six time units. The six tags all respond, in sequence, according to their respective delays. Since the reader knows at which times each tag is to respond, if a response is absent, the time of the absence indicates the identity of the missing tag. For example, if no response is heard at a delay of four time units, then it is known that tag number 4 is missing.

In another form of the invention, each tag issues a different response signal, thereby uniquely identifying itselo. Thus, in effect, tag 1 responds by saying “I am tag 1.” Tag 2 says, “I am tag 2.” And so on. Preferably, they respond in sequence, as discussed above, to avoid interfering with each other. However, it is possible for them to respond simultaneously, on different channels, or frequencies, as it were.

Other apparatus beside RFID devices can be used to implement the invention. So-called “speed pass cards,” which act as remotely readable credit cards, can be used. Proximity-sensitive key card systems, which are used to control access to buildings, can be used.

In one form of the invention, a switch is present which allows the owner to shut off the beeping, when a card is detected to be missing. This allows the owner to be informed of the missing card, but then to prevent continued beeping to annoy the owner and others.

In one form of the invention, an apparatus for securely connecting the reader to the luggage is added. For example, a lanyard may be attached to the reader, having a connector at the other end, which resembles the clasp on a dog leash. The connector is connected to, for example, a D-ring on the luggage. As another example, the reader can have a hook-and-loop backing, such as that sold under the name VELCRO (™). Another hook-and-loop backing is mounted to the luggage, with the then reader mounted to the latter.

These modes of attachment prevent the reader from accidentally falling out of the luggage.

It is pointed out that the reader has a limited range, such as a few feet. Only tags present within that range are effectively polled by the reader.

In one form of the invention, a testing routine is run. Reader 15 is equipped with a button or switch 50. When the button 50 is actuated, a routine polls each transponder 12, to determine whether all transponders are present. If so, light 55 is actuated, which may be green in color. If not, light 57 is actuated, which may be red in color, or the usual warning may sound.

The testing routine provides positive affirmation that all transponders are present, unlike normal operation, in which notice is given if a transponder is missing.

With this embodiment, for example, a person may drop the item of luggage containing the reader 15, and the luggage may pop open. As another example, the person may accidentally leave the item of luggage in a public place, and may return to the item, to find it open.

In either example, the person may wonder whether all transponders remain present. The person would actuate the testing routine to find out.

Numerous substitutions and modifications can be undertaken without departing from the true spirit and scope of the invention. What is desired to be secured by Letters Patent is the invention as defined in the following claims.

1. A kit, comprising:
a) a number of tags, each attachable to an item;
b) a controller which has a scanning range and, when activated,
i) periodically inquires whether all tags are present within the scanning range and, if not,
ii) issues a warning.

2. A method, comprising:
a) placing N remotely addressable tags into an item of luggage;
b) at intervals, using a controller to address the tags, to ascertain whether all N tags are present in the luggage; and
c) if one or more tags are found absent, causing the controller to issue a warning.

3. Method according to claim 2, wherein some tags are attached to credit cards stored within the luggage.

4. Method according to claim 2, wherein the tags are non-self-powered.

5. Method according to claim 2, wherein the tags receive operating power from incoming rf energy.

6. A method, comprising:
a) maintaining N remotely addressable tags in a purse, wherein each tag responds to an interrogation signal by returning an ID code, and
i) tag 1 returns ID code 1 after a time delay D1 following the interrogation signal;
ii) tag 2 returns ID code 2 after a time delay D2 following the interrogation signal;
iii) tag 3 returns ID code 3 after a time delay D3 following the interrogation signal, and so on, through
iv) tag N, which returns ID code N after a time delay DN following the interrogation signal.

7. Method according to claim 6, and further comprising:
b) if fewer than N ID codes are received, after an interrogation signal is issued, then issuing a warning.

8. Kit according to claim 1, wherein the tags are of the RFID type.

9. Kit according to claim 1, wherein controller comprises means to test whether all transponders are present, and issues a signal if they are not.

10. Method according to claim 2, and further comprising:
d) receiving a test command;
e) polling all tags;
f) if a tag is found missing, issuing a missing signal; and
g) if all tags are present, issuing an all-present signal.

11. Kit according to claim 1, wherein the tags are not attached to items when contained in the kit.

12. Kit according to claim 1, wherein the controller and the tags, when within the kit, are all within the field-of-view of a person.

13. Kit according to claim 1, wherein the kit, in kit form, will fit into a brief case.

14. Kit according to claim 1, wherein the warning is detectable by a human.

15. Kit according to claim 1, wherein the warning comprises an audible sound.

16. Kit according to claim 1, wherein the tags are attachable to items ordinarily found in a handbag.

17. Kit according to claim 9, wherein the signal is audible.

18. Kit according to claim 9, wherein the means to test is selectively actuable by a user, and can be actuated while the controller periodically inquires as in paragraph (b).

19. Kit according to claim 1, wherein all components of the kit are contained in a single, portable package.
